(19) United States
(12) Patent Application Publication
(10) Pub. No.: US 2006/0018340 A1
(43) Pub. Date: Jan. 26, 2006

(54) Transport stream processing apparatus

(75) Inventor: Sou Tamura, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/183,880

(22) Filed: Jul. 19, 2005

(30) Foreign Application Priority Data
Jul. 22, 2004 (JP) P2004-214414

(51) Int. Cl. H04J 15/00

(52) U.S. Cl. 370/464

(57) ABSTRACT

In a transport stream processing apparatus which executes a plurality of processings to thereby separate desired data from a transport stream (TS) according to the present invention, a hardware transport stream separating device executes a part of the plurality of processings using a hardware constitution; a software transport stream separating device executes a residual processing of the plurality of processings not executed by the hardware transport stream separating device using a software constitution; and a processing switching device switches the software transport stream separating device to be effective/ineffective in executing the residual processing.

### BACKGROUND OF THE INVENTION

1. Field of the Invention

The present invention relates to a transport stream processing apparatus and a transport stream processing method for processing data inputted by means of a transport stream packet format (hereinafter, referred to as TSP) and a digital broadcast receiver comprising the apparatus.

2. Description of the Related Art

The CS digital broadcast has been made available since 1995, and the BS digital broadcast has been made available since Dec. 1, 2000 in Japan. A broadcast station transmitting the foregoing broadcasts multiplexes image information and audio information obtained by compressing digital information and additional information appended to the informations such as program information according to the MPEG2 system standard to thereby generate a transport stream (TS), and digitally modulates and transmits the generated transport stream (TS). A digital broadcast receiver digitally demodulates the received signal to thereby obtain the transport stream (TS), and then separates the image, audio and other inforamtions from the obtained transport stream (TS) and reproduces them.

In the CS and BS digital broadcasts, the multiplexed data such as the image and audio is superposed on the transport stream (TS) as described, which is a data string having a fixed length generally called a transport stream packet (TSP), and then transmitted.

FIG. 3 is a schematic view illustrating a general format of the transport stream packet (TSP). The transport stream packet (TSP) is a packet having the fixed length of 188 bytes, the first four bytes of which are called a packet header. In the packet header, the first byte is a synchronous byte for synchronizing with a processing apparatus for processing the transport stream packet (TSP), in which a data value is always “47h” (h denotes a hexadecimal number). Subsequent to the first byte, a transport error indicator (TEI) bit for indicating “1” when a data error is detected in a digital demodulating circuit, a payload unit start indicator (PUSI) bit for denoting the presence of a section or a leading position of a packaged elementary stream (PES) packet, a transport scramble control (TSC) bit for indicating scramble information of the TSP, an adaptation field control (AFC) bit for indicating the presence/absence of an adaptation field, a continuity counter (CC) for indicating a packet continuity, and the like, are assigned in the packet header.

The fifth byte and thereafter of the transport stream packet (TSP) are comprised of an adaptation field of a variable length (N bytes) and a payload of a variable length (188-4-N bytes). The payload area stores the PES packet including the image, audio and subtitle, information for identifying a recipient, various service informations and the like.

The transport stream packet (TSP) is scrambled so that data can be viewed/listened by particular subscribers and then transmitted. Further, in the digital broadcast receiver, the received transport stream packet (TSP) is filtered so that only necessary data is retrieved therefrom. Accordingly, the digital broadcast receiver descrambles and filters the transport stream packet (TSP) and outputs the descrambled and filtered TSP. As examples of a destination of the output, a memory accessible by a processor (CPU), an AV decoder for retrieving the audio/image, a partial transport stream (partial TS) output port, and the like, can be mentioned. An apparatus, which applies the filtering process, descrambling process and the like to the transport stream packet (TSP) to thereby retrieve the desired data as in the described manner, is called a transport stream processing apparatus.

A conventional transport stream processing apparatus ranges in the following three constitutions. In one of them, all of the processing steps for the transport stream separation are executed by hardware. In the other two constitutions, all of the processing steps for the transport stream separation are executed by software, and the processing steps for the transport stream separation are divided between the hardware and the software.

Examples of the transport stream separating apparatus for executing all of a plurality of processing steps for the transport stream separation by the hardware are disclosed in No. H10-341419, No. 2000-13448 (P2000-13448A) and No. H11-239186 of the Publication of the Unexamined Japanese Patent Applications. An example of the transport stream separating apparatus for dividing the plurality of processing steps for the transport stream separation between the hardware and software is disclosed in No. H10-210461 of the Publication of the Unexamined Japanese Patent Applications. The cited reference No. 11-239186 further discloses an example of the transport stream separating apparatus for outputting a partial transport stream (PTS) obtained by applying a service information (SI) replacing process to the transport stream (TS).

The foregoing conventional transport stream processing apparatus have the following problems. The service information (SI) replacing process executed to the same transport stream (TS) ranges in different variations, which correspondingly generates a number of different situations and statuses in the output of the partial transport stream (PTS) and the like. Therefore, in an effort to deal with all the possible status and situations in the constitution for executing all of the processing steps using the hardware, a high operation frequency and an additional circuit are demanded. On the other hand, in an effort to deal with all the possible status and situations in the constitution for executing all of the processing steps using the software, a high power for the CPU is constantly required. In the case of the constitution in which the processing steps are divided, a maximum performance may not always be exerted because the processing steps are divided in a fixed manner

### SUMMARY OF THE INVENTION

Therefore, a main object of the present invention is to provide a transport stream processing apparatus capable of efficiently utilizing processing performances of hardware and software.

In order to attain the foregoing object, a transport stream processing apparatus according to the present invention for executing a plurality of processing steps in order to separate desired data from a transport stream (TS) is constituted as follows.

The transport stream processing apparatus according to the present invention comprises a hardware transport stream separating device for executing a part of the plurality of processing steps using a hardware constitution, a software transport stream separating device for executing a residual processing of the plurality of processing steps not executed by the hardware transport stream separating device using a software constitution, and a processing switching device for switching the software transport stream separating device to be effective/ineffective in executing the residual processing.

According to the present invention, the software processing is added depending on the situations so that a new processing, which could not be conventionally added without adding a new hardware constitution, can be realized without adding the new hardware constitution. Further, execution/non-execution of the additional processing can be selected when necessary.

As a result, the transport stream processing apparatus capable of efficiently utilizing the processing performances of hardware and software and the digital broadcast receiver comprising the apparatus can be realized according to the present invention.

### BRIEF DESCRIPTION OF THE DRAWINGS

Other objects of the invention will become clear by the following description of preferred embodiments and explicit in the appended claims of the invention. Many other benefits of the invention, which are not recited in this specification, will come to the attention of those skilled in the art upon implementing the present invention.

FIG. 1 is a block diagram illustrating an entire constitution of a transport stream processing apparatus according to a preferred embodiment of the present invention.

FIG. 2 is a flow chart according to the preferred embodiment.

FIG. 3 shows a constitution of a transport stream packet.

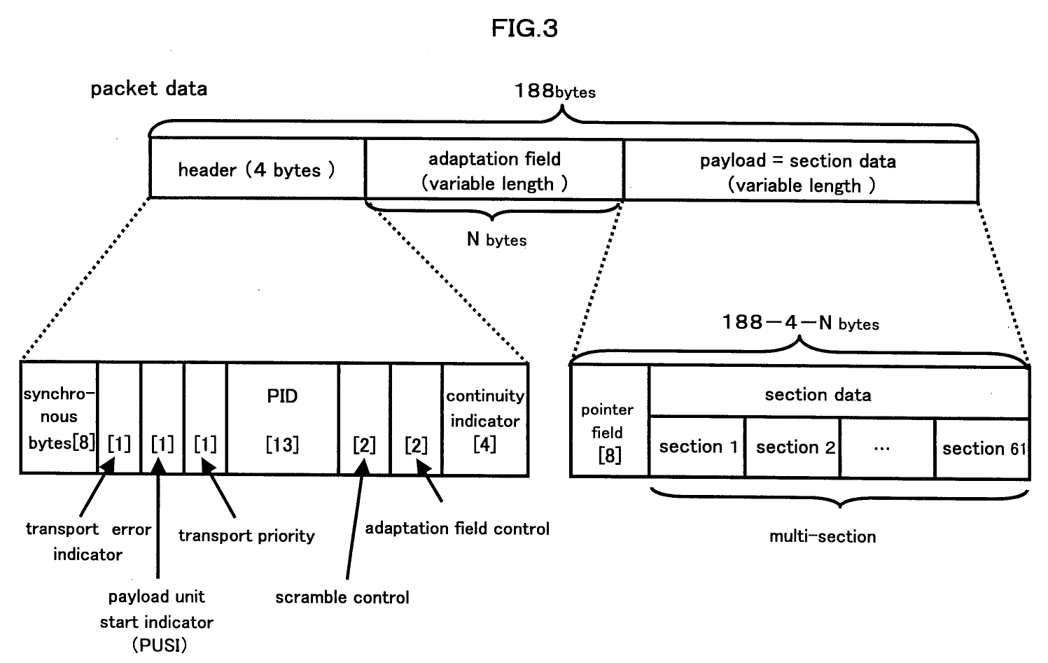

FIG. 4 is a block diagram illustrating a basic constitution of a transport stream processing apparatus to which the present invention is implemented.

FIG. 5 is a flow chart in the basic constitution of the transport stream processing apparatus to which the present invention is implemented.

### DETAILED DESCRIPTION OF THE INVENTION

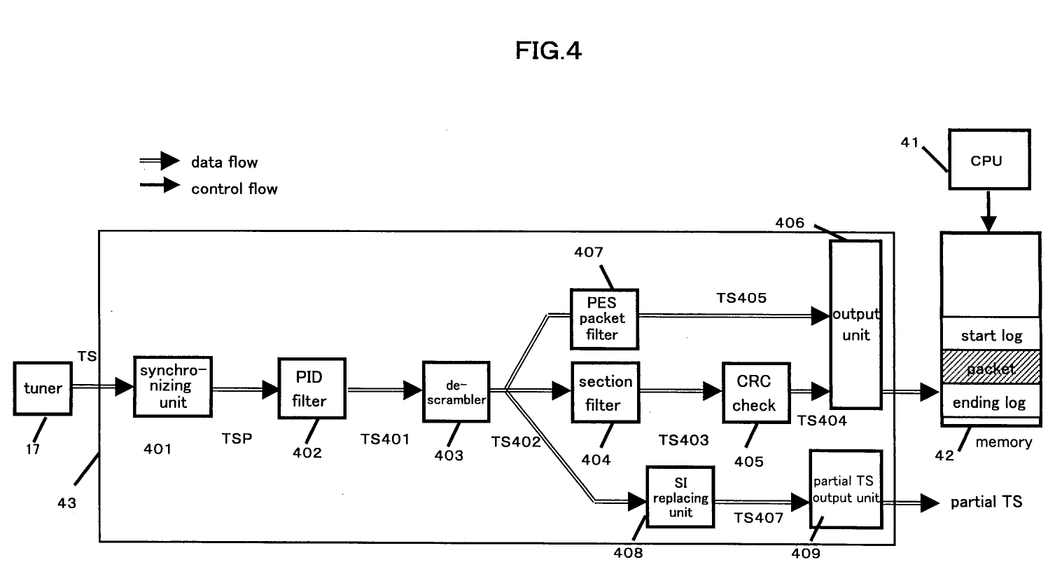

Prior to the description of a preferred embodiment of the present invention, an outline of a basic constitution relating to data reception in a digital broadcast receiver to which the present invention is implemented is described referring to FIG. 4.

In the digital broadcast receiver, a CPU (processor) 41, a memory (memorizing device) 42, a tuner 47 and a transport stream processing apparatus 43 are mainly responsible for the data reception.

The CPU 41 functions as a processor. The memory 42 is adapted to be accessible by software operated on the CPU 41. The tuner 47 frequency-selects a targeted carrier wave from received electric waves, demodulates and error-corrects the carrier wave, and further selects a transport stream from the carrier wave to thereby output the transport stream. The transport stream processing apparatus 43 functions as described earlier. In FIG. 4, a data flow and a control flow are respectively shown in arrows.

The transport stream processing apparatus 43 comprises a synchronizing unit 401, a PID filter 402, a descrambler 403, a section filter 404, a CRC checking unit 405, an output unit 406, a PES packet filter 407, a service information (SI) replacing unit 408 and a partial TS output unit 409. Identification data (PID) refers to packet identification data and synonymous with a packet identifier.

The synchronizing unit 401 detects leading data from the inputted transport stream (TS), and then extracts and outputs a transport stream packet (TSP).

The PID filter 402 outputs only the necessary transport stream packet (TSP) as TS401 and discards the unnecessary transport stream packet (TSP) based on identification data (PID) of the transport stream packet (TSP) inputted from the synchronizing unit 401.

The descrambler 403 judges a transport scramble control (TSC) superposed on the transport stream packet (TSP) as the TS401 inputted from the PID filter 402, and descrambles the TS401 and outputs it as TS402 when the TS401 is judged to be scrambled. The descrambler 403 dispenses with any processing with respect to the TS401 and immediately outputs it as the TS402 when the TS401 is judged to be non-scrambled.

The section filter 404 retrieves a section from the inputted TS402 (post-descrambling transport stream packet (TSP)) and filters a header part of the retrieved section to thereby output only the necessary section as TS403 to the CRC checking unit 405 and discard the unnecessary section.

The CRC checking unit 405 checks a CRC error (cyclic redundancy check error) of the section in the inputted TS403 to thereby append a result of the CRC check to the section and output it as TS404 to the output unit 406.

The output unit 406 outputs the inputted TS404 to the memory 42. However, the section including no CRC (section whose section syntax indicator (SSI)=0) is not subjected to the CRC check in the CRC checking unit 405 and outputted from the output unit 406.

The PES packet filter 407 retrieves a PES packet from the inputted TS402 and executes a filtering process in order to judge whether or not the retrieved PES packet is necessary. Then, the PES packet filter 407 outputs the PES packet judged to be necessary as TS405 to the output unit 406, while discarding the PES packet judged to be unnecessary. The output unit 406 outputs the inputted TS405 to the memory 42.

The service information (SI) replacing unit 408 and the partial TS output unit 409 are adapted to retrieve a necessary program from the inputted transport stream (TS) and output the retrieved program as a partial transport stream (PTS).

The service information (SI) replacing unit 408 synthesizes the inputted TS402 and the transport stream packet (TSP) including the section required in the output of the partial transport stream (PTS) (in which program information is stored) to thereby output a result of the synthesis as TS407.

Data stored in the section as the program information includes PAT (program association table), PMT (program map table), SIT (selection information table), DIT (discontinuity information table) and the like.

The partial TS output unit 409 outputs the TS407 outputted from the service information (SI) replacing unit 408 as the partial transport stream (PTS) outside of the transport stream processing apparatus.

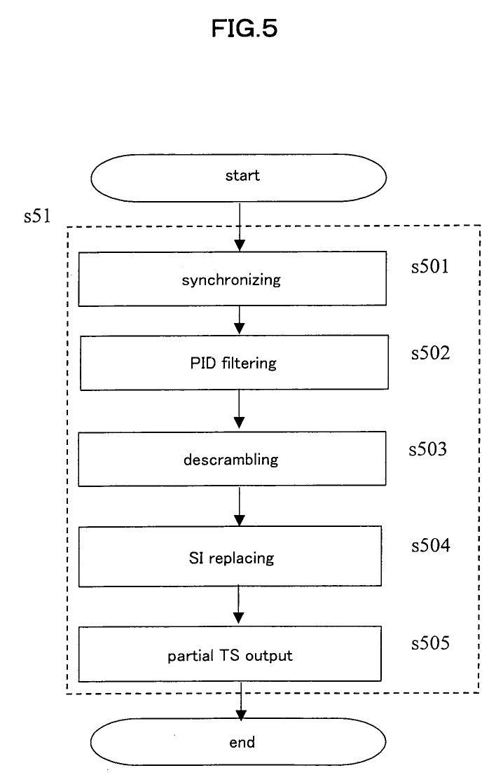

Next is described an examplified processing of the digital broadcast receiver in the case of executing the service information (SI) replacing process referring to a flow chart of FIG. 5. The flow chart represents a service information (SI) replacing step s51 using the hardware.

The step s51 comprises a synchronizing step s501, a PID filtering step s502, a descrambling step s503, a SI replacing step s504, a partial TS output step s505.

The synchronizing step s501 detects the leading data from the inputted transport stream (TS) and further extracts the transport stream packet (TSP) therefrom. The extracted transport stream packet (TSP) is provided with time stamp information indicating an arrival time thereof.

The PID filtering step s502 identifies the necessary transport stream packet (TSP) and the unnecessary transport stream packet (TSP) based on the identification data (PID) of the transport stream packet (TSP) processed in the step s501. Then, the PID filtering step s502 immediately outputs the necessary transport stream packet (TSP) and appends a discard log indicating that the unnecessary transport stream packet (TSP) is to be discarded to the relevant transport stream packet (TSP) and outputs it. In the step s502, the transport stream packet (TSP) to be subjected to the replacing process in the service information (SI) replacing step s504 is selected, and the transport stream packet (TSP) to be replaced is provided with a replacing log indicating that the relevant transport stream packet (TSP) is to be replaced and outputted.

The descrambling step s503 judges whether or not the relevant transport stream packet is scrambled based on the transport scramble control (TSC) stored in the transport stream packet (TSP) processed in the steps 502. Then, the descrambling step s503 descrambles the data when the data is judged to be scrambled, while omitting the descrambling process when the data is judged to be non-scrambled.

The service information (SI) replacing step s504 generates the transport stream packet (TSP) including the section in which the program information of the relevant transport stream packet (TSP) is stored with respect to the transport stream packet (TSP) processed in the step s53. To be specific, the transport stream packet (TSP) which is supplied with the replacing log in the step s502 is replaced with the desired transport stream packet (TSP), which is outputted, while the transport stream packet (TSP) which is supplied with the discard log in the step s502 is overwritten with the transport stream packet (TSP) including the section in which the program information is stored, which is outputted. Any packet having the discard log, which remains non-replaced, is discarded.

The partial transport stream (PTS) output step s505 outputs the transport stream packet (TSP) processed in the step s504 as the partial transport stream (PTS) in accordance with the time stamp outside of the transport stream processing apparatus.

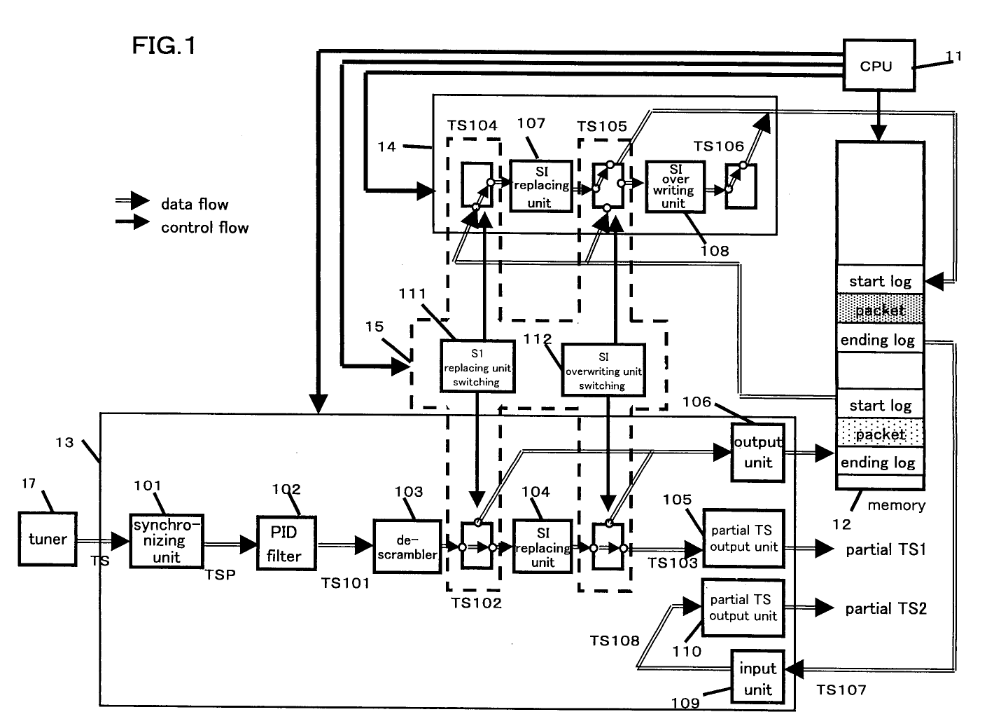

Next, a transport stream processing apparatus and a digital broadcast receiver comprising the transport stream processing apparatus according to the present embodiment are described in detail. FIG. 1 is a block diagram illustrating a schematic constitution relating to data reception in the digital broadcast receiver according to the present embodiment.

In the digital broadcast receiver, a CPU (processor) 11, a memory (memorizing device) 12, a tuner 17 and a transport stream processing apparatus are mainly engaged in the data reception in the same manner as in the constitution of FIG. 4. The memory 12 is adapted to be accessible by software operated on the CPU 11. The tuner 17 frequency-selects a targeted carrier wave from received electric waves, demodulates and error-corrects the carrier wave, and further selects a transport stream from the carrier wave and outputs the selected transport stream. In FIG. 1, single-lined arrows show a control flow and double-lined arrows show a data flow.

The transport stream processing apparatus is an apparatus for executing a plurality of processing steps in order to separate the desired data from the transport stream (TS).

The transport stream processing apparatus comprises a hardware transport stream separating device 13, a software transport stream separating device 14 and a processing switching device 15.

The hardware transport stream separating device 13 comprises a synchronizing unit 101, a PID filter 102, a descrambler 103, a service information (SI) replacing unit 104, partial transport stream (PTS) output units 105 and 110, an output unit 106, and an input unit 109. In the present embodiment, the output unit 106 constitutes a first output unit, and the partial transport stream (PTS) output unit 110 constitutes a second output unit.

The synchronizing unit 101 detects the leading data of the inputted transport stream (TS), and further extracts the transport stream packet (TSP) from the inputted the transport stream (TS). In the extraction, the synchronizing unit 101 appends the time stamp information indicating the arrival time of the transport stream packet (TSP) to the transport stream packet (TSP).

The PID filter 102 identifies the necessary packet and the unnecessary packet with respect to the transport stream packet (TSP) inputted from the synchronizing unit 101. The PID filter 102 then immediately outputs the necessary packet as TS101, while appending the discard log indicating that the relevant packet is to be discarded to the unnecessary packet and outputting it as the TS101.

The PID filter 102 judges the necessity of the transport stream packet (TSP) based on the identification data (PID) appended thereto. Further, the PID filter 102 appends the replacing log indicating that the relevant TSP is to be replaced to the transport stream packet (TSP) to be replaced by the service information (SI) replacing unit 104 disposed in a subsequent stage of the PID filter 102, and outputs it as the TS101.

The descrambler 103 judges the transport scramble control (TSC) appended to the TS101 to thereby judge whether or not the TS101 is scrambled. Then, the descrambler 103 descrambles the TS101 when the TS101 is judged to be scrambled and outputs it as TS102, while outputting the TS101 as the TS102 without executing any processing thereto when the TS101 is judged to be non-scrambled.

The service information (SI) replacing unit 104 synthesizes the transport stream packet (TSP) including the section containing the program information of the partial transport stream (PTS) into the TS102, and outputs it as TS103. More specifically, the transport stream packet (TSP) provided with the replacing log is replaced with the desired transport stream packet (TSP), which is outputted as the TS103. The transport stream packet (TSP) provided with the discard log is replaced with the transport stream packet (TSP) including the section in which the program information is stored, which is outputted. Any packet having the discard log, which remains non-replaced, is discarded.

The partial transport stream (PTS) output unit 105 outputs the TS103 inputted from the service information (SI) replacing unit 104 as a partial TS1 outside of the transport stream processing apparatus. The partial TS1 is outputted in accordance with the time stamp written in the TS103.

The output unit 106 outputs the TS102 inputted from the descrambler 103 to the memory 12.

The input unit 109 reads the data from the memory 12.

The partial transport stream (PTS) output unit 110 outputs TS107 read by the input unit 109 as a partial TS2 outside of the transport stream processing apparatus.

The software transport stream separating device 14 comprises a service information (SI) replacing unit 107 and a service information (SI) overwriting unit 108.

The service information (SI) replacing unit 107 synthesizes the inputted TS102 (post-descrambling transport stream packet (TSP)) and the relevant program information. More specifically, the transport stream packet (TSP) including the section required in the output of the partial transport stream (PTS) is synthesized into the TS102. Data stored in the required section is, for example, the program information. The synthesized data is outputted as TS105 to the memory 12 or the service information (SI) overwriting unit 108.

The program information stored in the section includes PAT (program association table), PMT (program map table), SIT (selection information table), DIT (discontinuity information table) and the like.

The service information (SI) overwriting unit 108 overwrites a part or all of the data in the sections (TS105, TS103) subjected to the service information (SI) replacing process by the service information (SI) replacing units 107 and 104. To describe the data overwriting, digital recording control data alone in a digital copy control descriptor as a descriptor included in the PMT (program map table), for example, is overwritten. The data whose service information (SI) is overwritten by the service information (SI) overwriting unit 108 is outputted and memorized in the memory 12 as TS106.

The service information (SI) replacing unit 107 and the service information (SI) overwriting unit 108 serve as the software whose processing is operated by the CPU 11.

The processing switching device 15 switches the software transport stream separating device 14 to be ineffective/effective. More specifically, the processing switching device 15 generates a service information (SI) replacing switching flag 111 for switching to and from ineffective/effective of the service information (SI) replacing unit 107 and a service information (SI) overwriting switching flag 112 for switching to and from ineffective/effective of the service information (SI) overwriting unit 108. In the present embodiment, the CPU 11 realizes the function of the processing switching device 15.

Below is described an operation of the transport stream processing apparatus. The leading data of the transport stream (TS) inputted to the transport stream processing apparatus is detected, and further, the transport stream packet (TSP) is extracted therefrom by the synchronizing unit 101. In extracting the transport stream packet (TSP), the transport stream packet (TSP) is supplied with the time stamp information indicating the arrival time thereof by the synchronizing unit 101.

The transport stream packet (TSP) outputted from the synchronizing unit 101 is selectively identified as the necessary transport stream packet (TSP) and the unnecessary transport stream packet (TSP) in the PID filter 102. The necessary transport stream packet (TSP) is immediately outputted as the TS102 from the PID filter 102, while the unnecessary transport stream packet (TSP) is supplied with the discard log by the PID filter 102 and outputted as the TS102 from the PID filter 102. Further, the transport stream packet (TSP) to be replaced in the subsequent service information (SI) replacing unit 104 is supplied with the replacing log by the PID filter 102 and then outputted as the TS101.

The TS101 is descrambled in the descrambler 103 and then outputted as the TS102. The descrambling is executed only to the TS101 which is scrambled.

A destination of the TS102 outputted by the descrambler 103 is selectively controlled in accordance with the setting (effective/ineffective) of the service information (SI) replacing switching flag 111. In other words, the setting of the service information (SI) replacing switching flag 111 (effective/ineffective) selectively controls ineffective/effective of the processing executed by the service information (SI) replacing unit 107.

Further, a destination of the TS103 outputted by the service information (SI) replacing unit 104 is selectively controlled in accordance with the setting (effective/ineffective) of the service information (SI) overwriting switching flag 112. In other words, the setting of the service information (SI) overwriting switching flag 112 (effective/ineffective) selectively controls ineffective/effective of the processing executed by the service information (SI) overwriting unit 108.

The service information (SI) replacing switching flag 111 and the service information (SI) overwriting switching flag 112 are previously set in the transport stream processing apparatus by an operator of the transport stream processing apparatus. The flags are set by the operator via an input device (input switch, keyboard or the like), which is not shown, provided in the transport stream processing apparatus. The inputted settings are inputted to the CPU 11 functioning as the processing switching device 15. The CPU 11 sets the service information (SI) replacing switching flag 111 and the service information (SI) overwriting switching flag 112 based on the inputted settings.

The effective/ineffective of the processings in the service information (SI) replacing unit 104 (hardware constitution), service information (SI) replacing unit 107 and service information (SI) overwriting unit 108 are set depending on combinations of the settings of the flags 111 and 112.

The settings range in the following patterns.

First Setting

flag 111: ineffective, flag 112: ineffective

In the first setting, the processing of the service information (SI) replacing unit 104 (hardware constitution) is effective, while the processing of the software transport stream separating device 14 (service information (SI) replacing unit 107 and service information (SI) overwriting unit 108) is ineffective.

Therefore, the TS102 outputted from the descrambler 103 is inputted to the service information (SI) replacing unit 104 (hardware). The service information (SI) replacing unit 104 synthesizes the inputted TS102 and the transport stream packet (TSP) including the section containing the program information and outputs the synthesizing result as the TS103 to the partial transport stream (PTS) output unit 105. The partial transport stream (PTS) output unit 105 outputs the inputted TS103 as the partial TS1 outside of the apparatus.

As described, in the first setting, the transport stream packet (TSP) is processed only in the hardware transport stream separating device 13 (PID filter 102, descrambler 103 and service information (SI) replacing unit 104) and outputted as the partial TS1 outside of the apparatus.

The setting is effective in the case in which the requested transport stream separation is completely executable using only the hardware transport stream separating device 13.

Second Setting

flag 111: ineffective, flag 112: effective

In the second setting, the processing of the service information (SI) replacing unit 104 (hardware constitution) and the processing of the service information (SI) overwriting unit 108 (software constitution) are effective, while the processing of the service information (SI) replacing unit 107 is ineffective.

Therefore, the TS102 outputted by the descrambler 103 is inputted to the service information (SI) replacing unit 104 (hardware). The service information (SI) replacing unit 104 synthesizes the inputted TS102 and the transport stream packet (TSP) including the section containing the program information, and outputs the synthesizing result as the TS103 to the output unit 106. The output unit 106 outputs the inputted TS103 to the memory 12.

The service information (SI) overwriting unit 108 whose processing is effective in the software transport stream separating device 14 reads the TS103 from the memory 12 and overwrites a part or all of the data therein. To describe the data overwriting, as mentioned earlier, the digital recording control data in the digital copy control descriptor as a descriptor included in the PMT (program map table), for example, is overwritten.

The service information (SI) overwriting unit 108 outputs the overwriting-processed data as the TS106 to the memory 12. The input unit 109 reads the TS106 from the memory 12 and outputs the read TS106 as TS108 to the partial TS output unit 110. The partial TS output unit 110 outputs the inputted TS108 as the partial TS2 outside of the apparatus.

As described, in the second setting, the transport stream packet (TSP) is processed in the hardware transport stream separating device 13 (PID filter 102, descrambler 103, and service information (SI) replacing unit 104), further, overwritten by the software in the service information (SI) overwriting unit 108 of the software transport stream separating device 14, and then outputted as the partial TS2 outside of the apparatus.

The setting is effective in the case in which the requested transport stream separation cannot be sufficiently executed by the hardware transport stream separating device 13, and the service information (SI) overwriting process is additionally demanded.

Third Setting

flag 111: effective, flag 112: ineffective

In the third setting, the processing of the service information (SI) replacing unit 107 (software constitution) is effective, while the processing of the service information (SI) replacing unit 104 (hardware constitution) and the processing of the service information (SI) overwriting unit 108 (software constitution) are ineffective.

Therefore, the TS102 outputted from the descrambler 103 is inputted to the service information (SI) replacing unit 107 (software constitution). The service information (SI) replacing unit 107 synthesizes the transport stream packet (TSP) including the section containing the program information into the inputted TS102, and outputs the synthesizing result as the TS105 to the memory 12. The input unit 109 reads the TS105 from the memory 12 and outputs the read TS105 as the TS108 to the partial TS output unit 110. The partial TS output unit 110 outputs the inputted TS18 as the partial TS2 outside of the apparatus.

As described, in the third setting, the transport stream packet (TSP) is processed only in the service information (SI) replacing unit 107 of the software transport stream separating device 14, and then outputted as the partial TS2 outside of the apparatus.

The setting is effective in the case in which the requested transport stream separation demands only the service information (SI) replacing process, and the replacing process can be more efficiently executed in the service information (SI) replacing unit 107 (software constitution) than in the service information (SI) replacing unit 104 (hardware constitution).

Fourth Setting

flag 111: effective, flag 112: effective

In the fourth setting, the processing of the entire constitution of the software transport stream separating device 14 (service information (SI) replacing unit 107 and service information (SI) overwriting unit 108) is effective, while the processing of the service information (SI) replacing unit 104 (hardware constitution) is ineffective.

Therefore, the TS102 outputted from the descrambler 103 is inputted to the service information (SI) replacing unit 107 (software constitution). The service information (SI) replacing unit 107 synthesizes the transport stream packet (TSP) including the section containing the program information into the inputted TS102, and outputs the synthesizing result as the TS105 to the service information (SI) overwriting unit 108. The service information (SI) overwriting unit 108 overwrites a part or all of the inputted data. An example of the overwriting is as described earlier.

The service information (SI) overwriting unit 108 outputs the overwriting-processed data as the TS106 to the memory 12. The input unit 109 reads the TS106 from the memory 12 and outputs the read TS106 as the TS108 to the partial TS output unit 110. The partial TS output unit 110 outputs the inputted TS108 as the partial TS2 to outside of the apparatus.

As described, in the fourth setting, the transport stream packet (TSP) is PID-filtered (PID filter 102) and descrambled (first descrambler 103) in the hardware transport stream separating device 13, and further processed in the software transport stream separating device 14 (service information (SI) replacing unit 107 and service information (SI) overwriting unit 108). Then, the processed data is outputted as the partial TS2 outside of the apparatus.

The setting is effective in the case in which the requested transport stream separation demands the service information (SI) replacing process and the service information (SI) overwriting process, and further, the service information (SI) replacing process can be more efficiently executed in the service information (SI) replacing unit 107 (software constitution) than in the service information (SI) replacing unit 104 (hardware constitution).

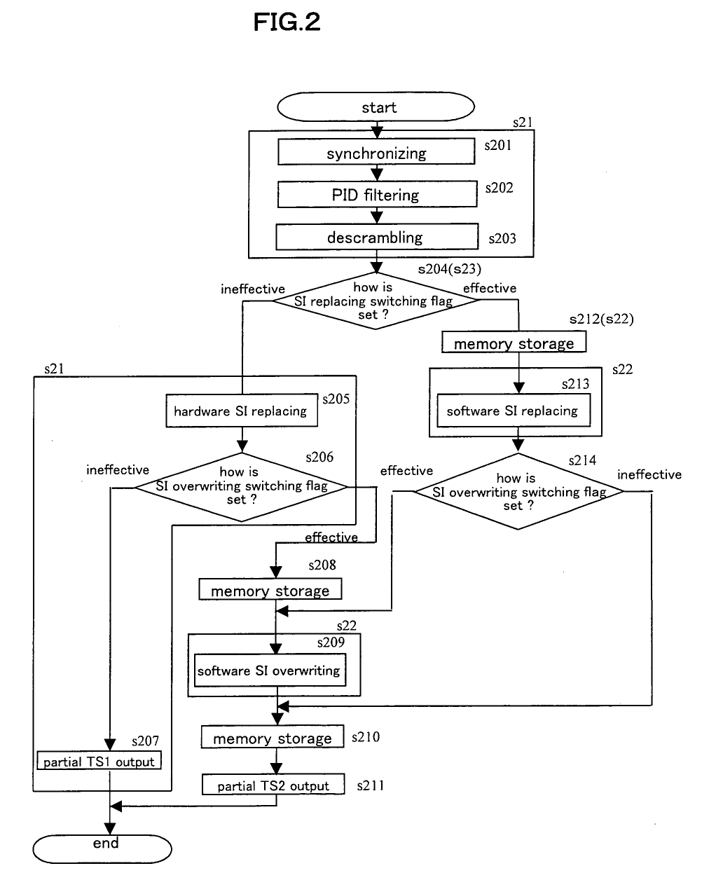

Next is described respective steps of a transport stream processing method carried out by the transport stream processing apparatus referring to a flow chart of FIG. 2.

In the operation of the transport stream processing apparatus, a service information (SI) replacing switching step s204 for switching to and from ineffective/effective of a service information (SI) replacing switching flag 111 is included as a processing switching step s23, and a service information (SI) replacing step s208 is included as a software transport stream separating step s22.

A hardware transport stream separating step s21 includes a synchronizing step s201, a PID filtering step s202, a descrambling step s203, a service information (SI) replacing step s205 and a partial TS1 outputs step s207.

Below is given a description based on the processing flow.

The step s201 is the synchronizing step, in which the leading data of the inputted transport stream (TS) is detected, and further, the transport stream packet is extracted from the inputted transport stream (TS). In the extraction, the transport stream packet (TSP) is provided with the time stamp information indicating the arrival time thereof.

The step s202 is the PID filtering step, in which the necessary packet and the unnecessary packet are identified with respect to the transport stream packet (TSP), and the necessary packet is directly outputted as the TS101, while the unnecessary packet is provided with the discard log indicating the discard and then outputted as the TS101.

The PID filtering process judges the necessity of the transport stream packet (TSP) based on the identification data (PID) appended to the packet. Further, in the replacing process, which is executed as the subsequent to the PID filtering, the replacing log indicating that the relevant transport stream packet (TSP) is to be replaced is appended to the transport stream packet (TSP) to be replaced.

The step 203 is the descrambling step, in which the transport scramble control (TSC) appended to the TS101 generated in the step s102 is judged so as to judge whether or not the TS101 is scrambled. When it is judged that the TS101 is scrambled, the TS101 is descrambled and outputted as the TS102. When the TS101 is judged to be non-scrambled, the TS101 is not subjected to any processing and outputted as the TS102. Then, the step s204 follows.

The step s204 is the service information (S19 replacing step, in which the service information (SI) replacing switching flag 111 is judged. When the flag 111 is judged to be ineffective, the processing proceeds to the hardware transport stream separating step s21 (to be specific, step s205). When the flag 111 is judged to be effective, the processing proceeds to a step s212.

The step s205 is the hardware service information (SI) replacing step, in which the transport stream packet (TSP) including the section containing the program information is synthesized into the TS102 descrambled in the step s203, and the synthesizing result is outputted as the TS103. In the step s205, the foregoing processing is hardware-executed.

In the step s205, the transport stream packet (TSP) having the replacing log is replaced with the desired transport stream packet (TSP), while the transport stream packet (TSP) having the discard log is used as a space for the replacing process with respect to the transport stream packet (TSP) including the section containing the program information with any unused portion being discarded.

A step s206 is the service information (SI) overwriting switching step, in which the service information (SI) overwriting switching flag 112 is judged. When the flag 112 is judged to be ineffective, the processing proceeds to the step s207 as a final step of the hardware transport stream separating steps 21. When the flag 112 is judged to be effective, the processing leaves the hardware transport stream separating step s21 and advances to a step s208.

The step s207 carried out when the flag 112 is judged to be ineffective in the step s206 is the partial TS1 output step, in which the TS103 generated in the step s205 is outputted as the partial transport stream 1 (partial TS1) outside of the transport stream processing apparatus in accordance with the time stamp. The time stamp is previously appended to the transport stream packet (TSP) in the synchronizing step s201. The processing flow is terminated in response to the execution of the processing of the step s207.

In contrast, the step s208 carried out when the flag 112 is judged to be effective in the step s206 is a memory storing step, in which the TS 103 generated in the step s205 is temporarily stored in the memory 12. Then, the processing proceeds to a step s209.

The step s209 is the service information (SI) overwriting step, in which the TS103 is read from the memory 12, and a part or all of the data in the sections of the read TS103 is overwritten so as to generate the TS106. More specifically, the digital recording control data alone in the digital copy control descriptor as a descriptor included in the PMT (program map table), for example, is overwritten. The step s209 executes the processing using the software constitution. After the generation of the TS106 in the step s209, the processing proceeds to a step s210.

The step s210 is the memory storing step, in which the TS105 generated in the step s209 is stored in the memory 12 accessible by the CPU 12. The memory storing steps s208 and s210 executed before and after the software service information (SI) overwriting step s209 temporarily store the TS103 and the TS105 in the memory 12 accessible by the software operated on the CPU 11 so that the service information (SI) overwriting step s209 as the software processing can be executed.

A step s211 is a partial TS2 output step, in which the TS105 stored in the memory 12 is read and outputted as the partial transport stream 2 (partial TS2) outside of the transport stream processing apparatus in accordance with the time stamp. The time stamp is previously appended to the transport stream packet (TSP) in the synchronizing step s201. The processing flow is terminated in response to the execution of the step s211.

The step s212 carried out when the flag 111 is judged to be effective in the step s204 is the memory storing step, in which the TS102 generated in the step s203 is stored in the memory 12 accessible by the CPU 11. Then, the processing advances to a step s213.

The steps 213 is the service information (SI) replacing step, in which the transport stream packet (TSP) including the section containing the program information is synthesized into the TS102 read from the memory 12, and the synthesizing result is outputted as the TS105. The steps 213 executes the processing using the software constitution. The processing advances from the step s213 to a step s214. The memory storing step s212 executed prior to the software service information (SI) replacing step s213 temporarily stores the TS102 in the memory 12 accessible by the software operated on the CPU 11 so that the service information (SI) replacing step s213 as the software processing can be executed.

The step s214 is the service information (SI) overwriting switching step, in which the service information (SI) overwriting switching flag 112 is judged.

When the flag 112 is judged to be effective in the step s214, the processing of the step s209 is executed so that a part or all of the data in the sections of the TS105 are overwritten so as to generate the TS106.

After the execution of the step s209, the steps s210 and s211 are executed so that the partial TS2 is generated. The generated partial TS2 is outputted outside of the transport stream processing apparatus. The processing flow is terminated in response to the execution of the step s211.

When the flag 112 is judged to be ineffective in the step s214, the step s209 (software service information (SI) overwriting process) is omitted, and the processing of the step s210 and the processing of the step s211 are executed so that the partial TS2 is generated. The generated partial TS2 is outputted outside of the transport stream processing apparatus. The processing flow is terminated in response to the execution of the processing of the step s211.

When the respective four settings are implemented, the processing shifts as follows in the flow chart of FIG. 2.

First Setting (flag 111: ineffective, flag 112: ineffective) start→step s201 step s202 step s203→step s204 (flag 111 is judged to be ineffective) step s205→step s206 (flag 112 is judged to be ineffective)→step s207 end

Second Setting (flag 111: ineffective, flag 112: effective) start→step s201→step s202→step s203→step s204 (flag 111 is judged to be ineffective)→step s2O5→step s206 (flag 112 is judged to be effective)→step s208 step 209→step s210→step s211→end

Third Setting (flag 111: effective, flag 112: ineffective) start→step s201→step s202→step s203→step s204 (flag 111 is judged to be effective)→step s212→step s213→step s214 (flag 112 is judged to be ineffective)→step s210→step s211→end

Fourth Setting (flag 111: effective, flag 112: effective) start→step s201→step s202→step s203→step s204 (flag 111 is judged to be effective)→step s212 step s213→step s214 (flag 112 is judged to be effective) step s209→step 210 step s211→end

When the partial TS1 subjected to the hardware service information (SI) replacing process and the partial TS2 subjected to the software service information (SI) replacing process are thus outputted, the constitution for outputting the partial transport streams (PTS) subjected to the service information (SI) replacing processes (replacing+overwriting) of the two types can be realized without an additional hardware service information (SI) replacing unit.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A transport stream processing apparatus for executing a plurality of processings for separating desired data from a transport stream (TS) comprising:
a hardware transport stream separating device for executing apart of the plurality of processings using a hardware constitution;
a software transport stream separating device for executing a residual processing of the plurality of processings not executed by the hardware transport stream separating device using a software constitution; and
a processing switching device for switching the software transport stream separating device to be effective/ineffective in executing the residual processing.

2. A transport stream processing apparatus as claimed in claim 1, wherein
the residual processing is a service information (SI) overwriting processing for overwriting a part or all of the sections included in the transport stream packet (TSP).

3. A transport stream processing apparatus as claimed in claim 1, further comprising:
a processor on which the software transport stream separating device is operated as the software; and
a memorizing device accessible by the software operated on the processor, wherein
the hardware transport stream separating device comprises a first output unit, an input unit and a second output unit,
the first output unit reads data currently being processed (hereinafter, referred to as currently-processed data) in the plurality of processings to be executed by the software transport stream separating device and memorizes the read data in the memorizing device when the processing switching device instructs execution of the residual processing by the software transport stream separating device,
the software transport stream separating device reads the currently-processed data memorized in the memorizing device and executes the residual processing thereto, and memorizes the processed data in the memorizing device when the processing switching device instructs the execution of the residual processing by the software transport stream separating device,
the input unit reads the processed data memorized in the memorizing device therefrom when the processing switching device instructs the execution of the residual processing by the software transport stream separating device, and
the second output unit outputs the processed data read by the input unit from the memorizing device as output data of the transport stream processing apparatus.

4. A transport stream processing apparatus as claimed in claim 3, wherein
the hardware transport stream separating device comprises as components for executing the plurality of processings:
a synchronizing unit for retrieving the data from the transport stream (TS) per a transport stream packet (TSP);
a PID filtering unit for PID-filtering the transport stream packet (TSP) retrieved per the packet by the synchronizing unit based on identification data (PID);
a descrambling unit for descrambling the PID-filtered transport stream packet (TSP); and
a service information (SI) replacing unit for generating a transport stream packet (TSP) required in outputting the descrambled transport stream packet (TSP) as a partial transport stream (PTS) and synthesizing the generated transport stream packet (TSP) into the descrambled transport stream packet (TSP), wherein
the software transport stream separating device comprises a service information (SI) overwriting unit for overwriting a part or all of the sections included in the transport stream packet (TSP) outputted from the service information (SI) replacing unit and outputting a result of the overwriting process,
the processed data outputted by the second output unit is the output of the service information (SI) overwriting unit.

5. A transport stream processing apparatus as claimed in claim 4, wherein
the processing switching device comprises a service information (SI) overwriting switching flag set by an operator of the transport stream processing apparatus, the processing switching device instructing the service information (SI) overwriting unit to operate when the service information (SI) overwriting switching flag is effective and instructing the service information (SI) overwriting unit not to operate when the service information (SI) overwriting switching flag is ineffective.

6. A transport stream processing method for executing a plurality of processing for separating desired data from a transport stream (TS) comprising:
a hardware transport stream separating step for executing a part of the plurality of processings using a hardware constitution;
a software transport stream separating step for executing a residual processing of the plurality of processings not executed by the hardware transport stream separating step using a software constitution; and
a processing switching step for switching the software transport stream separating step to be effective/ineffective in executing the residual processing.

7. A transport stream processing apparatus as claimed in claim 6, wherein
the residual processing is a service information (SI) overwriting processing for overwriting a part or all of the sections included in the transport stream packet (TSP).

8. A transport stream processing method as claimed in claim 6, wherein
the hardware transport stream separating step includes a first memorizing step, a reading step and an output step,
the software transport stream separating step includes a residual processing executing step and a second memorizing step,
the first memorizing step is a step of reading data currently being processed (hereinafter, referred to as currently-processed data) in the plurality of processings to be executed by the software transport stream separating step and memorizing the read data in a memorizing device when the processing switching step instructs execution of the residual processing by the software transport stream separating step,
the residual processing executing step is a step of reading the currently-processed data memorized in the memorizing device and executing the residual processing thereto when the processing switching step instructs the execution of the residual processing by the software transport stream separating step,
the second memorizing step is a step of memorizing the data processed by the residual processing executing step in the memorizing device,
the reading step is a step of reading the processed data memorized in the memorizing device when the processing switching step instructs the execution of the residual processing by the software transport stream separating step, and
the output step is a step of outputting the processed data read from the memorizing device as output data of the transport stream processing method.

9. A transport stream processing method as claimed in claim 8, wherein the plurality of processing steps includes:
a synchronizing step for retrieving the data from the transport stream (TS) per a transport stream packet (TSP);
a PID filtering step for PID-filtering the transport stream packet (TSP) based on identification data (PID);
a descrambling step for descrambling the PID-filtered transport stream packet (TSP); and
a service information (SI) replacing step for generating a transport stream packet (TSP) required in outputting the descrambled transport stream packet (TSP) as a partial transport stream (PTS) and synthesizing the generated transport stream packet (TSP) into the descrambled transport stream packet (TSP), wherein
the software transport stream separating step includes a service information (SI) overwriting step for overwriting a part or all of the sections included in the transport stream packet (TSP) processed by the service information (SI) replacing step and outputting a result of the overwriting process, and the processed data outputted by the output step is the output of the service information (SI) overwriting step.

10. A transport stream processing method as claimed in claim 9, further including a step of setting the switching flag based on an operation of an operator as a preliminary step executed before the plurality of processings, and
the processing switching step instructs execution of the residual processing by the software transport stream separating step when the switching flag is effective, and instructs non-execution of the residual processing by the software transport stream separating step when the switching flag is ineffective.

11. A digital broadcast receiver comprising a tuner for receiving a digital broadcast including the transport stream (TS) and the transport stream processing apparatus claimed in claim 1.
